(19) United States
(12) Patent Application Publication
(10) Pub. No.: US 2018/0092482 A1
(43) Pub. Date: Apr. 5, 2018

(54) Shoehorn identification tag

(71) Applicant: Andrew Lock, Cedarhurst, NY (US)

(72) Inventor: Andrew Lock, Cedarhurst, NY (US)

(21) Appl. No.: 15/284,748

(22) Filed: Oct. 4, 2016

(51) Int. Cl. A47G 25/82; G09F 3/00

(52) U.S. Cl. CPC A47G 25/82; G09F 3/0288

(57) ABSTRACT

A combination of identification tag and shoehorn which combine a device for helping put on shoes and identification indicia within the unitary tag. The device comprises of a smooth curved implement of a material of relatively thin dimensions that is inserted into a heel of a shoe to ease the foot into and make it slip on more easily and also of a carved space to attach a tag with a name and address of an individual. The carved space is allowing easy removal or insertion of an identification tag by the user under the carved transparent window.

### BACKGROUND OF THE INVENTION

### I. Field of the Invention

The present invention relates generally to the field of identification devices and more particularly to a device, which not only has the qualities of promoting identification of a person's property, but performs a utilitarian function in combination therewith. Such function is to allow the user to use the device for putting on shoes more easily, by providing a smooth surface for the foot and the heel to move, without crushing the vertical portion of the shoe that wraps around the back of the foot.

### II. Description of the Prior Art

In the field of identification tags and shoehorns, there are numerous examples of these devices, but generally they are separate and apart from one another. (see United States patents
1. U.S. Pat. No. 3,429,065
2. U.S. Pat. No. 5,476,289
3. U.S. Pat. No. 2,811,797
4. U.S. Pat. No. 7,624,525
5. U.S. Pat. No. 5,381,617
6. U.S. Pat. No. 5,158,179)

Typically there have been tags in which a person may put a business card, or even attach advertising indicia thereto, and the tag would have some sort of securing means such as a strap which would be held to the property identified.

Further, there have been numerous prior art devices which are used to help a user to easily insert a foot into a shoe.

Typically, the devices of the prior art do not combine the functions of identification and a shoehorn.

### SUMMARY OF THE INVENTION

The device of this invention has two features, no single one of which is solely responsible for its desirable attributes.

The first feature of this invention is of the tag which identifies a property of the user. This tag can be easily attached to property by a loop.

The second feature of this invention is of a shoehorn that allows the user to easily insert a foot into a shoe.

This device is easily manufactured and is relatively inexpensive. Other objects, advantages and capabilities of the invention will become apparent from the following description taken in conjunction with the accompanying drawings, showing only a preferred embodiment of the invention.

### BRIEF DESCRIPTION OF THE DRAWINGS (CONSULT A PATENT DRAWING PROFESSIONAL)

FIG. 1 is a perspective view of device from the top with shoehorn in it and

FIG. 1A is a side straight view from the tip of the device where the shoehorn is inserted, when the shoehorn is inside the device.

FIG. 2 is a perspective view from the top with partially ejected shoehorn;

FIG. 3 is a perspective view from the bottom with partially ejected shoehorn;

FIG. 4 is an exploded view of the device.

FIG. 5 is a view of the device while attached to a suitcase and an image of a man using the device.

### DETAILED DESCRIPTION OF THE PREFERRED EMBODIMENT

The preferred embodiment of this invention, illustrating all its features, will now be discussed in detail. This embodiment depicts the novel and non-obvious device of this invention shown in the accompanying drawing, which is for illustrative purposes only.

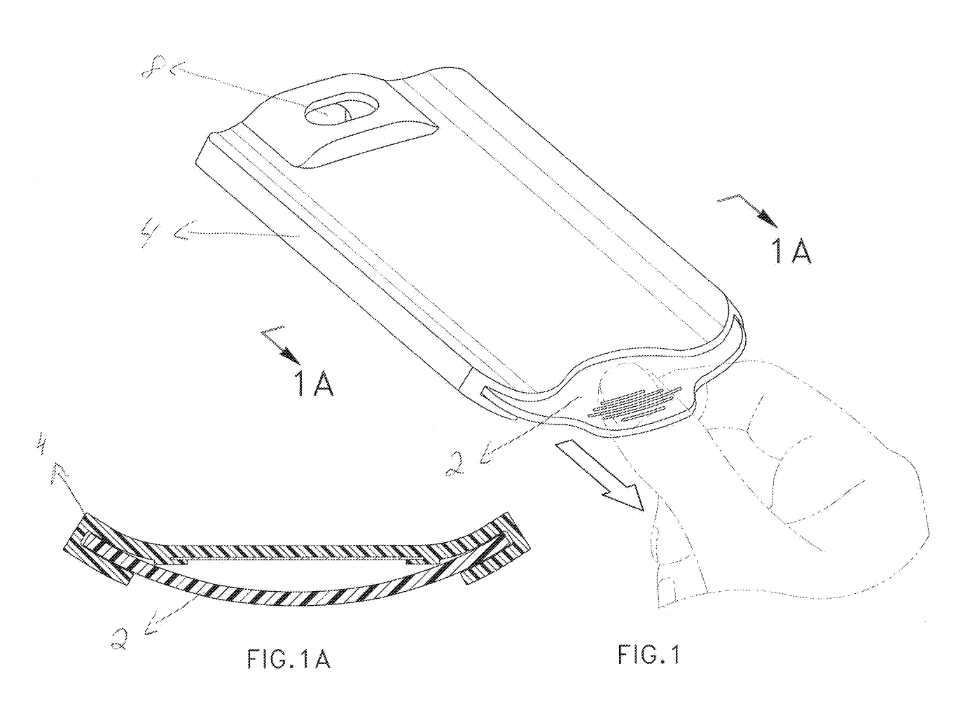

The shoehorn identification tag includes a case 4 having two slots on the sides into which the shoehorn 2 is inserted and held. There is a centrally located hole 8 at the front end of case which is used to attach the case 4 to a bag. The sides of case 4 are in curvy shape to allow insertion of shoehorn 2 which also has curvy shape as shown in FIG. 1A.

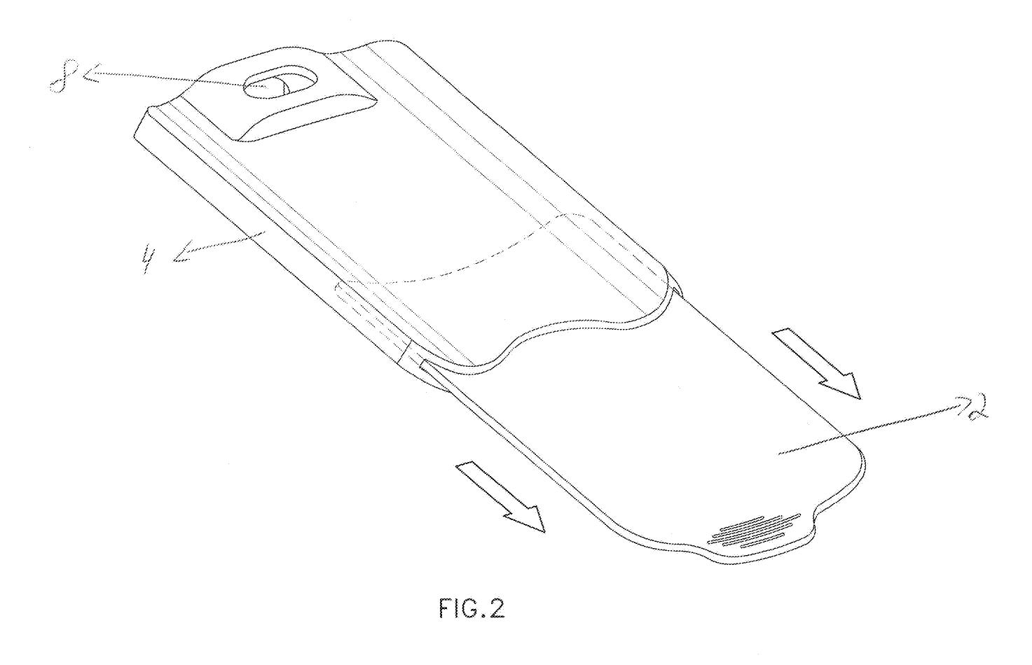

FIG. 2 shows how shoehorn 2 is retracted from inside the case 4 and slides out when user needs to use it. The tip of the shoehorn is exposed and is not covered by case 4 to allow easy retraction and insertion once user finishes using the shoehorn.

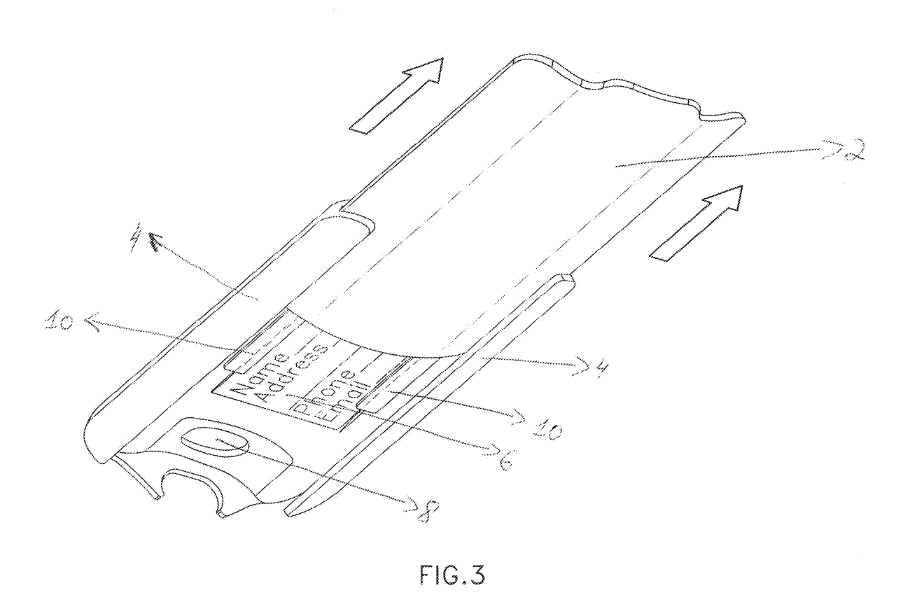

FIG. 3 shows a bottom view of the case 4 which reveals embodied longitudinal slots 10 for insertion and removal of identification tag 6. Identification tag 6 includes identification information when the bag to which the identification tag is attached is lost or needs to be identified for any reason. Longitudinal slots 10 which are embodied to case 4 secure the identification tag 6 in place once inserted.

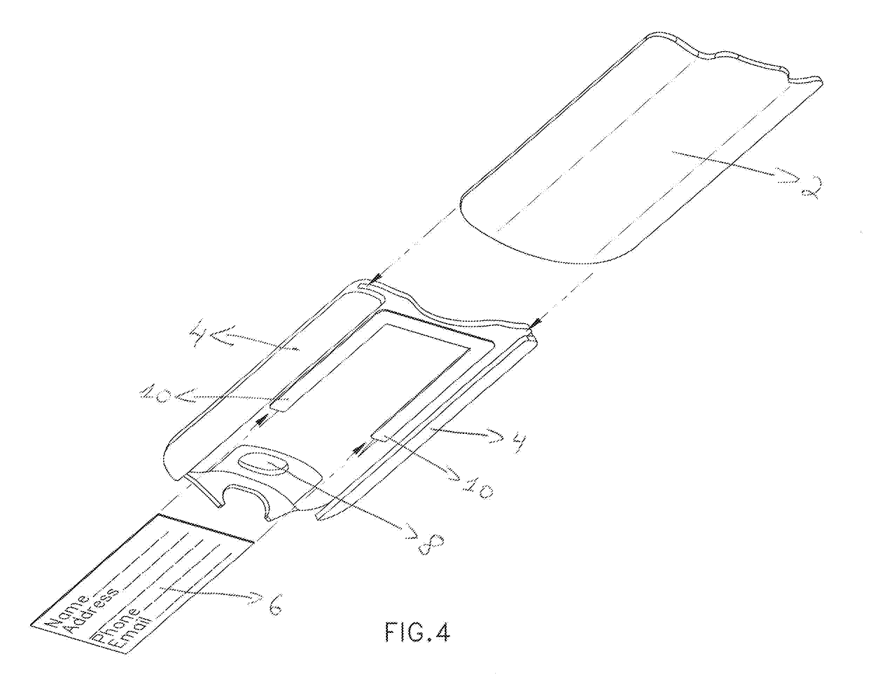

FIG. 4 shows exploded view of the device with shoehorn 2 removed, the identification tag 6 removed from longitudinal slots 10 which are embodied in the case 4 and a centrally located hole 8.

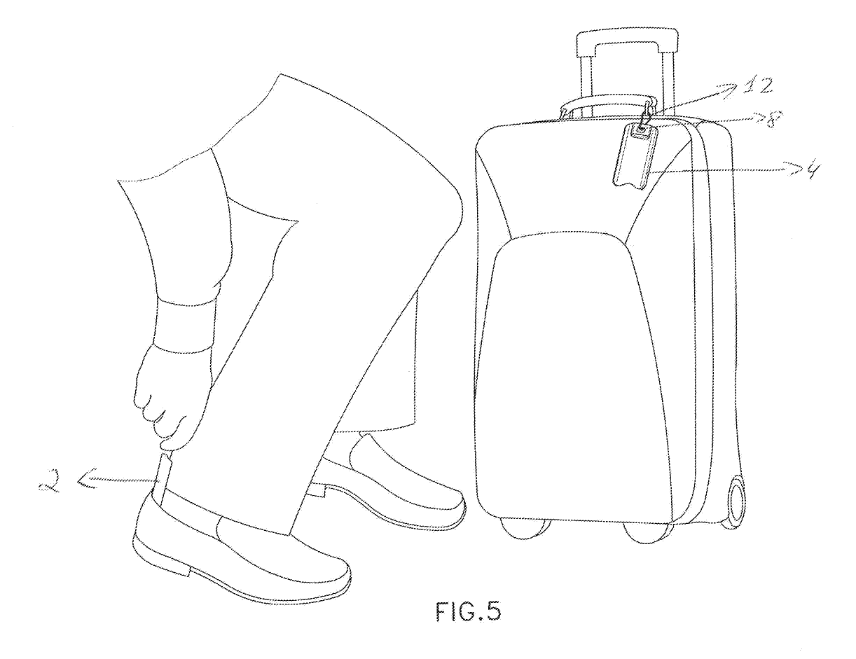

FIG. 5 shows how a conventional string or clip 12 is attached to a centrally located hole 8 which holds the case 4. The conventional string or clip is then attached to the luggage or bag and the identification tag and shoehorn are fastened to a bag or luggage.

The above presents a description of the best mode con templated of carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above which are fully equivalent. Consequently, it is not the intention to limit this invention to the particular embodiment disclosed. On the contrary, the intention is to cover all modifications and alternate constructions coming within the spirit and scope of the invention as generally expressed by the following claims, which particularly point out and distinctly claim the subject matter of the invention.

We claim:

1. A device adapted to be attached to a bag, comprising
a case having slightly curved sides with embodied slots, said slots hold a shoehorn, said shoehorn covers an identification tag, said tag is inserted into embodied longitudinal slots on an inside of the case that enables a user to have direct access to an identification tag, the tag is hidden from plain view and shoehorn can be attached to luggage in one device,
said device is attached to luggage by a conventional string, strap or clip through a hole in the case.

2. A device as defined in claim 1 wherein the identification tag case secured to luggage with string, strap or clip,
said string, strap or clip is integral part of the device.

3. A combination of:
an identification luggage tag case with two curvy slots on sides into the sides a shoehorn is inserted and held, said case having longitudinal slots in inner body of the case such longitudinal slots are embodied in the case; and
a shoehorn having a curvy shape said shoehorn allows a user to easily insert a foot into a shoe.

4. The combination of claim 3 wherein said shoehorn is transparent and allows an observant of a device to identify a luggage immediately by looking at the identification tag without removing the shoehorn from the curvy slots on the sides of the case.
